(19) United States
(12) Patent Application Publication
(10) Pub. No.: US 2013/0056990 A1
(43) Pub. Date: Mar. 7, 2013

(54) Modular Wind Turbine

(71) Applicant: Randy D. Sines, Spokane, WA (US)

(72) Inventor: Randy D. Sines, Spokane, WA (US)

(21) Appl. No.: 13/225,032

(22) Filed: Sep. 2, 2011

(51) Int. Cl. F03D 9/00

(52) U.S. Cl. 290/55

(57) ABSTRACT

A generation unit to generate electricity from wind may include a first modular housing having a plurality of first partition members to define a plurality of first slots, a plurality of first air baffles positioned within the first slots, a plurality of first turbine blades positioned to cooperate with the first air baffles within the first slots, a second modular housing having a plurality of second partition members to define a plurality of second slots, a plurality of second air baffles positioned within the second slots, and a plurality of second turbine blades positioned to cooperate with the second air baffles within the second slots.

### FIELD OF THE INVENTION

This application is generally related to the field of energy-generating wind turbines, particularly modular wind turbines.

### BACKGROUND

The renewable energy sources are important in order to guarantee a sustainable power production in the future. Wind power is a large and mostly renewable energy source in the production of electricity. However, the use of wind power is constrained by the availability of a reliable source of wind and the use of wind turbines. Large wind turbines are generally considered unsightly and may be a source of noise pollution. These factors tend to limit the use of wind turbines to wind turbine farms which may be located at remote locations such as far out to sea or in generally unpopulated areas. Today, conventional wind power is constrained by land use, environmental concerns and high up-front capitalization.

Thus there is a need for a robust wind power system that meets the above-mentioned criteria. Clearly, there is also a need to utilize the energy of wind for generation of electric power.

The present invention is intended to satisfy that needs.

Because of the steady depletion of easily obtainable carbon based fuels, such as petroleum and coal, there is an accelerating search for non-carbon based and renewable energy sources. One such renewable energy resource is wind power. Over centuries many types of devices designed to harness blowing wind to generate mechanical energy or, more recently, electrical energy have been developed. The famous windmills of the Netherlands and elsewhere have been and still are used for milling grain and pumping water out of low lying land areas.

Energy producing wind machines are usually called wind turbines and are broadly classified into two groups—horizontal axis wind turbines (HAWT) and vertical axis wind turbines (VAWT). Horizontal axis turbines are more prevalent and comprise a turbine that rotates around a horizontal axis. The main rotor shaft and generator are located at the top of a supporting tower and must be pointed into the wind by some means.

There are several common problems associated with HAWT machines. The more powerful horizontal axis turbines have long blades that require accurate placement out of the way of both natural and man-made obstructions and can create a safety hazard. They generate significant noise so as to cause some reluctance to have them installed near populated areas. In areas of high wind, the backward force and torque on a horizontal axis wind turbine blade peaks as it turns through the highest point of its arc. The tower hinders the air flow at its lowest point on the arc producing a local decrease in force and torque. These opposing high and low torque conditions can produce torsion on the bearings and support towers.

Vertical axis wind turbines overcome many of the problems of the HAWTs. The turbine of the VAWT spins on a vertical axis on top of the support tower thus making operation much safer for people on the ground near the tower. The VAWT is able to receive wind from any direction and therefore does not require any mechanical or computer-directed turning mechanism to keep the turbine facing in the right direction. The generator may be placed on or near the ground so the tower is not required to support the generator in addition to the turbine itself.

However, VAWTs do have drawbacks. Like HAWTs, vertical axis turbines usually have a pulsating torque that is produced during each revolution of the turbine. This occurs because of the lift and drag produced by the turbine as it spins. For each wind direction, there is a point in the revolution that produces the most lift and an opposing point that produces the most drag on the turbine. To reduce the pulsating effect, it is advantageous to achieve maximum turbine rotation as soon and efficiently as possible.

Coupled with the pulsating effect is the fact that two main types of VAWTs exist—the Savonius turbine which is a high speed, low torque turbine and the Darrieus turbine, which is a low speed, high torque turbine, efficiency of the Darrieus type of vertical wind turbine.

Wind turbines provide a primary source of energy that can be converted into electricity and supplied to utility power grids. Conversion of wind energy to electrical energy is accomplished in a wind turbine by driving an electrical generator, commonly an AC induction generator. If the electrical power generated by a wind turbine is to be supplied to a utility power grid, then it is required to have a constant frequency, e.g., 60 Hertz, that is synchronized to the utility line frequency. This can be accomplished by driving the generator at a constant rotational speed, which, unless a variable speed transmission is used, requires that the wind turbine rotate at a constant speed. Unfortunately, constant speed operation of a wind turbine limits its energy conversion efficiency due to variable wind conditions. Turbine rotor speed needs to be proportional to wind speed for optimal energy recovery.

Variable speed wind turbines have been proposed as a way of increasing the energy conversion efficiencies of constant speed wind turbines. By varying the rotor speed in varying wind conditions, improved energy recovery can be achieved over a range of wind speed. Also importantly, the peak mechanical stresses caused by wind gusts can be reduced by limiting the torque reacted on the wind turbine by the generator and allowing the wind turbine to speed up in response to wind gusts. The increased kinetic energy of the rotor caused by wind gusts serves as a short term energy storage medium to further improve energy conversion. Such operation, however, requires a responsive torque control system.

Although variable speed wind turbines are advantageous from the perspective of increased energy conversion and reduced stresses, the electrical generation system is more complicated than that of a constant speed wind turbine. Since a generator is usually coupled to a variable speed rotor through a fixed-ratio gear transmission, the electrical power produced by the generator will have a variable frequency. This requires a conversion from the variable frequency AC output by the generator to a constant frequency AC for supplying the utility power grid. The conversion can be accomplished either directly by a frequency converter or through an intermediate conversion to DC by a rectifier and reconversion to fixed-frequency AC by an inverter.

### SUMMARY

A generation unit to generate electricity from wind may include a first modular housing having a plurality of first partition members to define a plurality of first slots, a plurality of first air baffles positioned within the first slots, a plurality of first turbine blades positioned to cooperate with the first air baffles within the first slots, a second modular housing having a plurality of second partition members to define a plurality of second slots, a plurality of second air baffles positioned within the second slots, and a plurality of second turbine blades positioned to cooperate with the second air baffles within the second slots.

The first modular housing may be detachably connected to the second modular housing.

The first modular housing may be detachably connected to the second modular housing in the substantially vertical direction.

The first modular housing may be detachably connected to the second modular housing in the substantially horizontal direction.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the modular housing of the generation unit of the present invention;

FIG. 2 illustrates a sectional view of the generation unit of the present invention;

FIG. 3 illustrates a front view of the generation unit of the present invention;

FIG. 4 illustrates a side view of the generation unit of the present invention;

FIG. 5 illustrates another side view of the generation unit of the present invention;

FIG. 6 illustrates a top view of the generation unit of the present invention;

FIG. 7 illustrates a bottom view of the generation unit of the present invention;

FIG. 8 illustrates a front view of a first generation unit being detachably connected to a second generation unit in a vertical direction.

FIG. 9 illustrates a front view of a first generation unit being detachably connected to a second generation unit in a horizontal direction.

FIG. 10 illustrates a control circuit for the first and second generation unit of the present invention.

### DETAILED DESCRIPTION

The most desirable to implement or cost-effective wind power system must produce the required amount of electricity and be optimal in terms of cost, size, weight, and reliability. Other essential qualities of such a system are modular design.

A modular wind power system is made of a number of standardized units or modules that can be fitted together to construct a large power system in a variety of ways. Another advantage of a modular technology is that particular modules may be interchanged, added to or removed from the site system as required (i.e. in response to increases or decreases in system usage requirements). Such gives a time advantage for installation, modification, repairs and maintenance, thereby insuring that the system is more cost-competitive.

The present invention provides a wind turbine system which may include a “modular” system but can provide a multiple detachably connected wind turbines which may be detached to form a single wind turbine to generate power by a modest wind. The system can include of one or more generation units.

By using one or more rotating members in a vertical plane or horizontal plane or both in which the wind only impacts the blades as they are moving in the desired direction, same as the wind, great efficiencies are created.

Wind is directed to the blades in such a manner that approaching 100% of the wind is directed onto the blades.

The surface area of the blades approaches 50% of the vertical footprint of the system, while in the case of traditional 3-blade generators, only a small fraction of the wind (within the circular footprint) actually impacts the blades.

With the modular system of the present invention, the height of the wind generator modules may be only a fraction of the height of traditional 3-blade (or more) wind generators/turbines whose support with axis point that must stand a minimum in height of the length of each blade for the blades to circulate.

The vertical footprint of the wind generator modules of the system may be only a fraction of a traditional wind generator while generating the same power and is much less an “eyesore”.

The wind generator modules may be adapted such that the number of units connected will be dependent on the power requirements.

The wind generator modules may be configured with rotating bases and vanes so that the units can stay perpendicular to the wind (like windmills), or the wind generator modules may be powered to do the same.

The wind generator modules may be configured to include a substantially low profile such that the wind generator modules may be less of an “eyesore” as a tall traditional 3 or more blade “windmill” type system. The wind generator modules may only be a foot in height, and with modular capabilities, might encircle the top of a building with little impact on vision, etc.

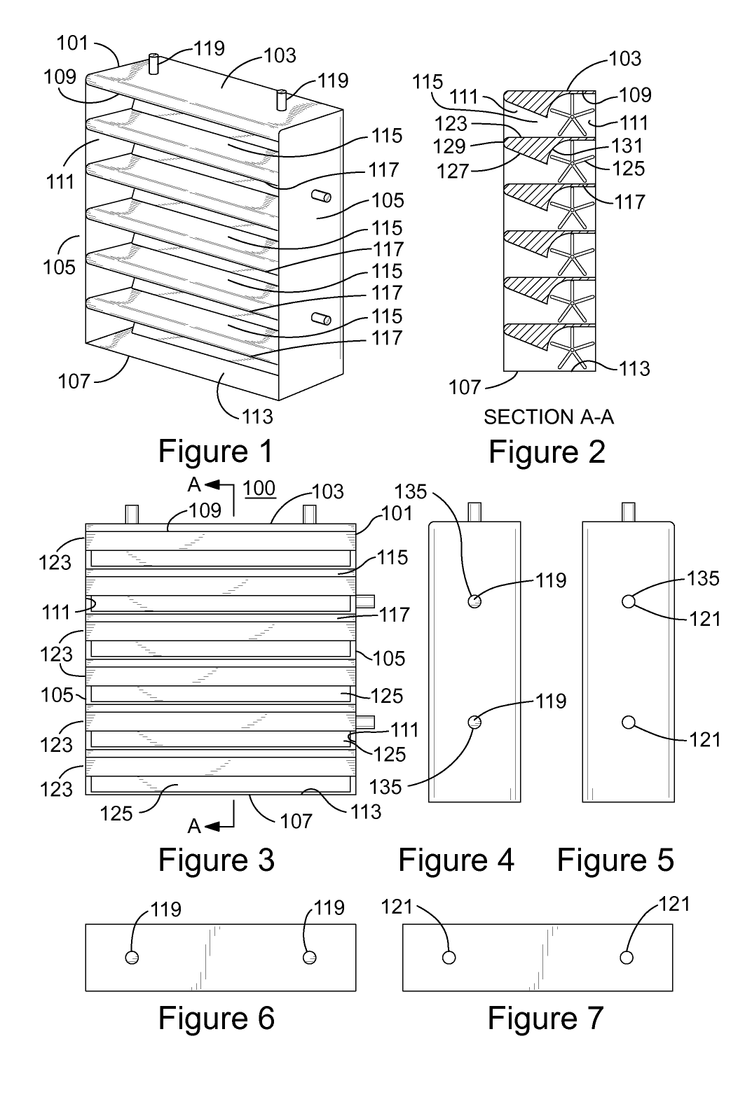

FIG. 1 illustrates the modular housing 101 of the generation units 100 which may include an exterior top surface 103 which may be connected to an opposing pair of exterior side surfaces 105 which may connect to an exterior bottom surface 107. The generation unit maybe formed from rigid material such as metal, plastic or other such materials. FIG. 1 additionally illustrates the modular housing 101 having a hollow interior being defined by a interior top surface 109 connected to a pair of opposing interior side surface 111 which may be connected to an interior bottom surface 113. Furthermore, the modular housing 101 may include a multitude of slots 115 which may be defined by partition members 117 which may be rectangular in shape and extend from the interior side surface 111 to the opposing interior side surface 111. A first modular housing 101 may be connected to a second modular housing 101 by connecting pins 119 which may extend from the top surface 103 or/and the exterior side surface 105 in order to cooperate with connecting apertures 121 which may be formed in the exterior bottom surface 107 and/or the opposing exterior side surface 105.

FIG. 3 illustrates the generation unit 100 and the modular housing 101 of the generation unit 100 which may include an exterior top surface 103 which may be connected to an opposing pair of exterior side surfaces 105 which may connect to an exterior bottom surface 107. FIG. 3 additionally illustrates the modular housing 101 having a hollow interior being defined by a interior top surface 109 connected to a pair of opposing interior side surface 111 which may be connected to an interior bottom surface 113. Furthermore, the modular housing 101 may include a multitude of slots 115 which may be defined by partition members 117 which may be rectangular in shape and extend from the interior side surface 111 to the opposing interior side surface 111. A first modular housing 101 may be connected to a second modular housing 101 by connecting pins 119 which may extend from the top surface 103 or/and the exterior side surface 105 in order to cooperate with connecting apertures 121 which may be formed in the exterior bottom surface 107 and or the opposing exterior side surface 105.

FIG. 3 additionally illustrates a multitude of air baffles 123 which may extend between the interior side surface 111 and the opposing interior side surface 111. The air baffle 123 may be formed within the slot 115 to direct air to the turbine blade 125 which may extend substantially between the interior side surface 111 and the opposing interior side surface 111. Each slot 115 may include the air baffle 123 and the turbine blade 125.

FIG. 2 illustrates a section view along section A-A of FIG. 3 and FIG. 2 illustrates the exterior top surface 103, the exterior bottom surface 107, the slot 115, the partition member 117 the interior top surface 109 interior bottom surface 113, the exterior bottom surface 107, the air baffle 123 and the turbine blade 125. The air baffle 123 may include a top baffle surface 125 which may be connected to a front baffle surface 129 and connected to a back curved baffle surface 131 which may be connected to a bottom baffle surface 127. The back curved baffle surface 131 may be curved to cooperate with the turbine blade 125 which may have a multitude of blades. The generation unit 100 may be horizontally stackable or may be vertically stackable and may be connected with a fastener device 135 which may be connection pin 119 and may be a connection aperture 120 to cooperate with the connection pins 119 or may be another type of appropriate fastener device 135.

FIG. 4 illustrates a side view of the generation unit 100 and illustrates the exterior side surface 105 having a connection pin 119 which extend out of the side surface 105, and FIG. 5 illustrates an opposing exterior side surface 105 having a connection aperture 121 formed in the surface of the exterior side surface 105.

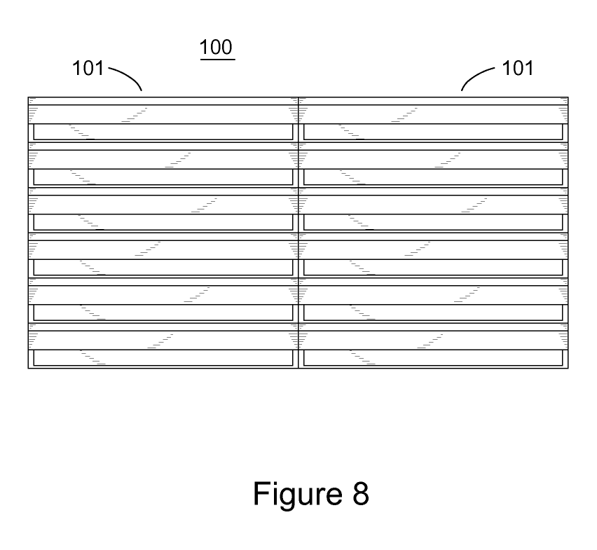

By the cooperation of the connection pin 119 and the connection aperture 121, the first generation unit 100 including the first modular housing 101 may be detachably connected to the second generation unit 100 including the second modular housing 101 in the substantially vertical direction as illustrated in FIG. 8. The first generation unit and the first modular housing may be substantially mirrored in the second generation unit and a second modular housing.

FIG. 6 illustrates a top view of the generation unit 100 and illustrates the exterior top surface 103 having a connection pin 119 which extend out of the top surface 103, and FIG. 7 illustrates and exterior bottom surface 107 having a connection aperture 121 formed in the surface of the exterior bottom surface 107.

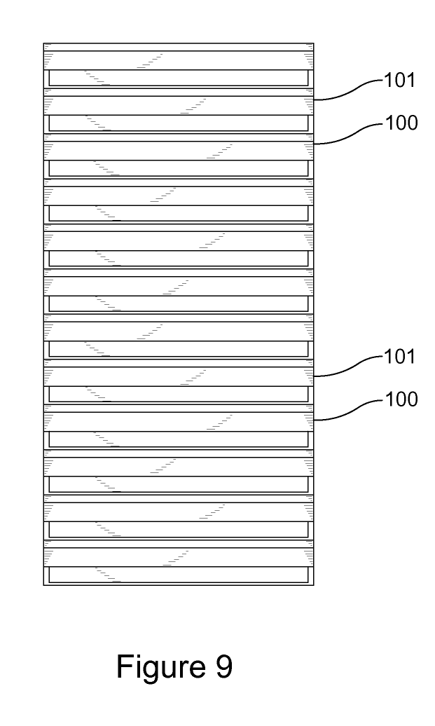

By the cooperation of the connection pin 119 and the connection aperture 121, the first generation unit 100 may be detachably connected to the second generation unit 100 in the substantially horizontal direction as illustrated in FIG. 9. The first generation unit and the first modular housing may be substantially mirrored in the second generation unit and a second modular housing.

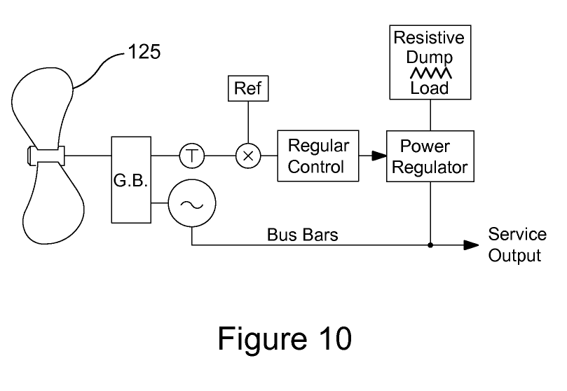

Control of the generation units is shown in FIG. 10; here the speed of the air turbine is monitored by means of the tachometer T which may be mounted on the turbine shaft or the generator shaft. The output from the tachogenerator is compared to a reference and when the tachogenerator output increases above the reference value, a signal is passed to a regulator control system which progressively turns on a power regulator allowing the energy in the bus bars to be dissipated to a resistive dump load. Typically the power regulator could by a thyristor stack arranged to change progressively from fully off to fully on over the required speed range.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A generation unit to generate electricity from wind, comprising:
a first modular housing having a plurality of first partition members to define a plurality of first slots;
a plurality of first air baffles positioned within the first slots;
a plurality of first turbine blades positioned to cooperate with the first air baffles within the first slots;
a second modular housing having a plurality of second partition members to define a plurality of second slots;
a plurality of second air baffles positioned within the second slots;
a plurality of second turbine blades positioned to cooperate with the second air baffles within the second slots,
wherein the first modular housing is detachably connected to the second modular housing.

2) A generation unit to generate electricity from wind as in claim 1, wherein the first modular housing is detachably connected to the second modular housing in the substantially vertical direction.

3) A generation unit to generate electricity from wind as in claim 1, wherein the first modular housing is detachably connected to the second modular housing in the substantially horizontal direction.
